(19) United States
(12) Patent Application Publication
(10) Pub. No.: US 2026/0051635 A1
(43) Pub. Date: Feb. 19, 2026

(54) DIRECT FOIL TO TERMINAL CONNECTION DESIGNS FOR PRISMATIC CELL MANUFACTURING

(71) Applicant: GM Global Technology Operations LLC, Detroit, MI (US)

(72) Inventors: Junjie Ma, Novi, MI (US); Matthew Arthur Celentano, Berkley, MI (US); John Christian Kalil, Washington, MI (US); Teresa Jean Rinker, Royal Oak, MI (US); Subrahmanyam Goriparti, Troy, MI (US); Reza Kavian, Sterling Heights, MI (US); Masoud MohammadPour, Novi, MI (US); Blair E. Carlson, Ann Arbor, MI (US)

(73) Assignee: GM Global Technology Operations LLC, Detroit, MI (US)

(21) Appl. No.: 18/806,182

(22) Filed: Aug. 15, 2024

(51) Int. Cl. H01M 50/566; H01M 50/103; H01M 50/15; H01M 50/176; H01M 50/55

(52) U.S. Cl. CPC H01M 50/566; H01M 50/103; H01M 50/15; H01M 50/176; H01M 50/55; H01M 2220/20

(57) ABSTRACT

A method for manufacturing a prismatic battery assembly includes disposing a plurality of current collector tabs at least partially through a slot of a cap of an enclosure. The plurality of current collector tabs are electrically connected to respective current collectors of an electrode stack and extend from an end of the electrode stack. The enclosure accommodates the electrode stack. The cap has an interior side that extends along the end of the electrode stack and an exterior side opposite the interior side. The slot is formed through the cap between the exterior side and the interior side. With the plurality of current collector tabs disposed at least partially through the slot, the method includes electrically connecting the plurality of current collector tabs to a terminal plate disposed at the exterior side of the cap and hermetically sealing the enclosure.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a prismatic battery having electrode stacks electrically connected to terminal plates at a cap of the battery.

Typically, the electrode stacks of a prismatic battery electrically connect to the terminal plates of the battery cap via current collectors of the electrode stacks welded to internal terminal leads at the battery cap. That is, the battery cap includes internal terminal leads disposed at an interior side of the battery cap that are electrically connected to terminal plates disposed at an exterior side of the battery cap. To provide access to the terminal plates and current collectors during manufacturing of the battery, the current collectors are welded to the terminal leads with the electrode stacks spread apart relative to one another or oriented in a substantially horizontal manner relative to the battery cap. Following welding, the electrode stacks are then moved together and oriented in a substantially vertical manner relative to the battery cap for placement within the battery assembly. Moving the electrode stacks to the vertical orientation after welding the current collectors to the terminal leads causes the current collectors to fold or bend relative to the terminal leads, which may lead to increased stress on the current collectors. Under certain conditions, such as when a vehicle equipped with the prismatic battery is in motion, the current collector may tear or disconnect from the terminal lead due to relative movement between the current collectors and the terminal leads. Further, because the connection between the current collectors and the terminal leads is at the interior side of the battery cap, the battery assembly must provide sufficient clearance between the interior side of the battery cap and the electrode stacks, leading to increased packaging for the battery assembly.

### SUMMARY

One aspect of the disclosure provides a method for manufacturing a prismatic battery assembly. The method includes disposing a plurality of current collector tabs at least partially through a slot of a cap of an enclosure. The plurality of current collector tabs are electrically connected to respective current collectors of an electrode stack and extend from an end of the electrode stack. The enclosure accommodates the electrode stack. The cap has an interior side that extends along the end of the electrode stack and an exterior side opposite the interior side. The slot is formed through the cap between the exterior side and the interior side. With the plurality of current collector tabs disposed at least partially through the slot, the method includes electrically connecting the plurality of current collector tabs to a terminal plate disposed at the exterior side of the cap. With the plurality of current collector tabs electrically connected to the terminal plate, the method includes hermetically sealing the enclosure.

Implementations of the disclosure may include one or more of the following optional features. In some implementations, disposing the plurality of current collector tabs at least partially through the slot includes collecting the plurality of current collector tabs, and moving the cap relative to the end of the electrode stack to feed the plurality of current collector tabs at least partially through the slot. The cover plate hermetically seals the enclosure.

In some examples, with the plurality of current collector tabs disposed at least partially through the slot, the plurality of current collector tabs extend through the slot of the cap and at least partially along the terminal plate at the exterior side of the cap. The plurality of current collector tabs are disposed between the terminal plate and a cover plate. In further examples, with the plurality of current collector tabs extending at least partially along the terminal plate, the plurality of current collector tabs are accommodated within a recess formed between the terminal plate and the cover plate. The recess may extend partially into one of the terminal plate and the cover plate.

In some aspects, with the plurality of current collector tabs disposed at least partially through the slot, the plurality of current collector tabs extend through the slot of the cap and the plurality of current collector tabs extend at least partially through a slot of the terminal plate. In further aspects, electrically connecting the plurality of current collector tabs to the terminal plate includes attaching the plurality of current collector tabs to the terminal plate at the slot of the terminal plate. In even further aspects, the method further includes attaching a cover plate to the terminal plate. The cover plate extends over the plurality of current collector tabs and the slot of the terminal plate and hermetically seals the enclosure.

In some implementations, electrically connecting the plurality of current collector tabs to the terminal plate includes attaching the plurality of current collector tabs to a lead tab. The lead tab is electrically connected to the terminal plate and extends within the slot of the cap.

In some examples, electrically connecting the plurality of current collector tabs to the terminal plate includes laser welding the plurality of current collector tabs. The plurality of current collector tabs are laser welded to the terminal plate.

Another aspect of the disclosure provides a prismatic battery assembly. The prismatic battery assembly includes an electrode stack having a plurality of current collector tabs electrically connected to respective current collectors of the electrode stack. The plurality of current collector tabs extend from an end of the electrode stack. An enclosure accommodates the electrode stack. The enclosure includes a cap. The cap has an interior side that extends along the end of the electrode stack and an exterior side opposite the interior side. A slot is formed through the cap between the exterior side and the interior side. The plurality of current collector tabs extend at least partially through the slot. A terminal plate is disposed at the exterior side and is electrically connected to the plurality of current collector tabs. This aspect may include one or more of the following optional features.

In some implementations, the plurality of current collector tabs extend through the slot of the cap and at least partially along the terminal plate at the exterior side of the cap. The plurality of current collector tabs are disposed between the terminal plate and a cover plate. In further implementations, the plurality of current collector tabs are accommodated within a recess formed between the terminal plate and the cover plate.

In some examples, the plurality of current collector tabs extend through the slot of the cap and at least partially through a slot of the terminal plate. The plurality of current collector tabs are attached to the terminal plate at the slot of the terminal plate.

In some aspects, the plurality of current collector tabs extend partially through the slot and are attached to a lead tab. The lead tab is electrically connected to the terminal plate and extends within the slot of the cap.

Yet another aspect of the disclosure provides a vehicle including a prismatic battery assembly. The prismatic battery assembly includes an electrode stack having a plurality of current collector tabs electrically connected to respective current collectors of the electrode stack. The plurality of current collector tabs extend from an end of the electrode stack. An enclosure accommodates the electrode stack. The enclosure includes a cap. The cap has an interior side that extends along the end of the electrode stack and an exterior side opposite the interior side. A slot is formed through the cap between the exterior side and the interior side. The plurality of current collector tabs extend at least partially through the slot. A terminal plate is disposed at the exterior side and is electrically connected to the plurality of current collector tabs. This aspect may include one or more of the following optional features.

In some implementations, the plurality of current collector tabs extend through the slot of the cap and at least partially along the terminal plate at the exterior side of the cap. The plurality of current collector tabs are disposed between the terminal plate and a cover plate. In further implementations, the plurality of current collector tabs are accommodated within a recess formed between the terminal plate and the cover plate.

In some examples, the plurality of current collector tabs extend through the slot of the cap and at least partially through a slot of the terminal plate. The plurality of current collector tabs are attached to the terminal plate at the slot of the terminal plate.

In some aspects, the plurality of current collector tabs extend partially through the slot and are attached to a lead tab. The lead tab is electrically connected to the terminal plate and extends within the slot of the cap.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle equipped with a prismatic battery assembly.

FIG. 2 is a perspective view of an example prismatic battery assembly.

FIGS. 3A and 3B are perspective views of a terminal plate of the prismatic battery assembly of FIG. 2.

FIG. 4 is a perspective view of electrode stacks of the prismatic battery assembly of FIG. 2 having current collector tabs attached to an interior side of the terminal plate with the electrode stacks moved away from one another and from the interior side of the terminal plate.

FIGS. 5A-5C are views of another example prismatic battery assembly having current collector tabs extending through slots formed in the cap of the prismatic battery assembly for attachment to the terminal plate at an exterior side of the cap.

FIGS. 6A and 6B are perspective views of the cap of the prismatic battery assembly of FIGS. 5A-5C.

FIG. 7 is a perspective view of the cap of the prismatic battery assembly of FIGS. 5A-5C, showing cover plates removed from the terminal plates of the cap.

FIG. 8 includes sectional views of example cover plates and terminal plates for the prismatic battery assembly of FIGS. 5A-5C.

FIG. 9 is a schematic diagram of an example method for manufacturing the prismatic battery assembly of FIGS. 5A-5C.

FIGS. 10A-10C are views of another example prismatic battery assembly having current collector tabs extending through slots formed in the cap of the prismatic battery assembly for attachment to the terminal plate at or within slots of the terminal plate.

FIG. 11 is a schematic diagram of an example method for manufacturing the prismatic battery assembly of FIGS. 10A-10C.

FIGS. 12A-12C are views of another example prismatic battery assembly having current collector tabs extending through slots formed in the cap of the prismatic battery assembly for attachment to the terminal plate at or within slots of the terminal plate.

FIG. 13 is a perspective view of the cap of the prismatic battery assembly of FIGS. 12A-12C.

FIG. 14 is a schematic diagram of an example method for manufacturing the prismatic battery assembly of FIGS. 12A-12C.

FIGS. 15A-15C are views of another example prismatic battery assembly having current collector tabs attached to terminal lead tabs that extend through slots formed in the cap of the prismatic battery assembly, and the terminal lead tabs attach to the terminal plate at or within slots of the terminal plate.

FIG. 16A is a sectional view of the electrode stack and current collector tabs of the prismatic battery assembly of FIGS. 15A-15C, with the current collector tabs attached to a two-piece terminal lead tab.

FIG. 16B is a sectional view of the electrode stack and current collector tabs of the prismatic battery assembly of FIGS. 15A-15C, with the current collector tabs attached to a U-shaped terminal lead tab.

FIG. 17 is a schematic diagram of an example method for manufacturing the prismatic battery assembly of FIGS. 15A-15C.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

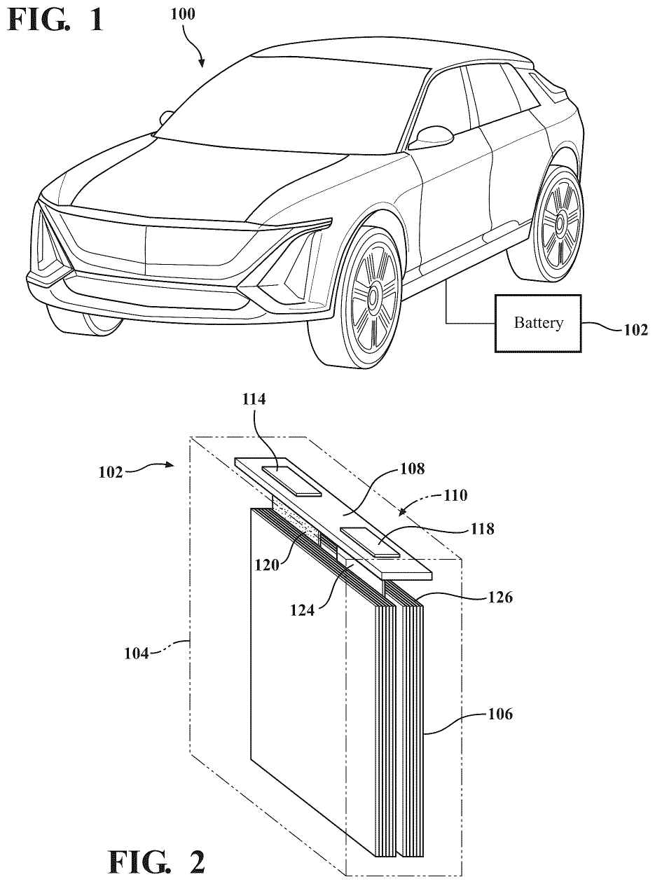

Referring now to the drawings the illustrated examples depicted therein, a vehicle 100, such as an electric vehicle (EV) or plug-in hybrid vehicle (PHEV) or a hybrid vehicle, includes a rechargeable prismatic battery assembly 102, such as a lithium ion battery assembly, that at least partially powers a propulsion system of the vehicle 100 (FIGS. 1 and 2). The battery 102 includes an enclosure 104, such as a housing or casing, that accommodates a plurality of electrode stacks 106 or battery cells. The electrode stacks 106 receive and discharge electrical current during operation of the battery 102, and the battery 102 electrically connects to the propulsion system and/or other external circuits of the vehicle 100 via a terminal plate 108 that is disposed at or integrated with a cap assembly 110 of the battery enclosure 104.

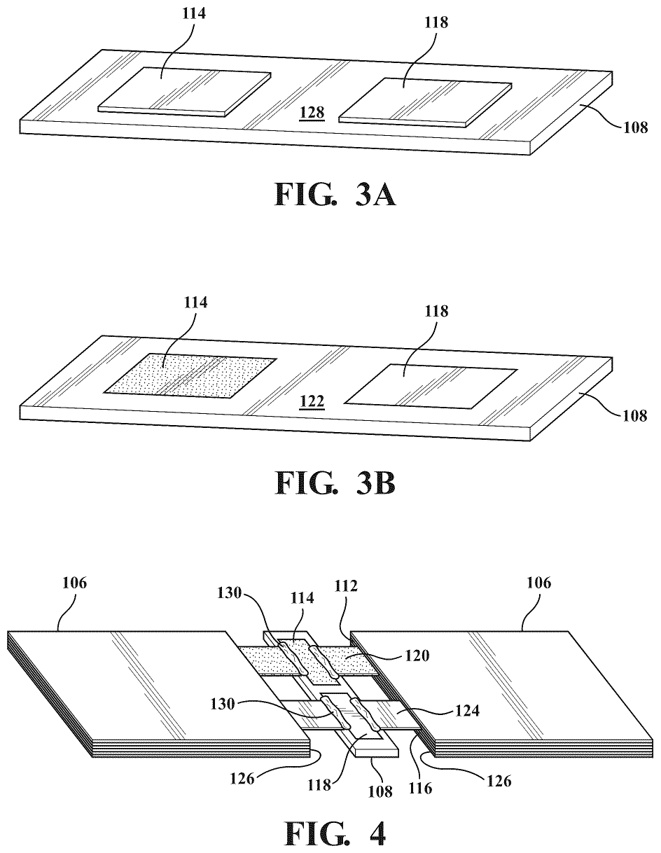

Each electrode stack 106 of the battery 102 includes a first current collector 112 or anode current collector electrically connected to a negative terminal 114 at the terminal plate 108 and a second current collector 116 or cathode current collector electrically connected to a positive terminal 118 at the terminal plate 108. For example, the anode current collector 112 electrically connects to the negative terminal 114 via a respective tab 120 or anode current collector tab attached to a portion of the negative terminal 114 at a first side 122 or interior side of the terminal plate 108. The cathode current collector 116 electrically connects to the positive terminal 118 via a respective tab 124 or cathode current collector tab attached to a portion of the positive terminal 118 at the interior side 122 of the terminal plate 108. The anode current collector tab 120 and the cathode current collector tab 124 each extend from a first end 126 or edge of the electrode stack 106. As shown in FIGS. 2-4, the interior side 122 of the terminal plate 108 faces and extends along the first end 126 of the electrode stack 106 at an interior portion of the enclosure 104 and a second side 128 or exterior side of the terminal plate 108 is opposite the interior side 122. Respective portions of the negative terminal 114 and the positive terminal 118 disposed at the exterior side 128 of the terminal plate 108 electrically connect to the external circuits of the vehicle 100.

In the illustrated example of FIGS. 2-4, the battery 102 includes two electrode stacks 106 electrically connected to the terminal plate 108 via respective welds 130 formed between the anode current collector tabs 120 and the negative terminal 114 and between the cathode current collector tabs 124 and the positive terminal 118. Because the electrode stacks 106 are attached to the interior side 122 of the terminal plate 108, the welds 130 are formed with the electrode stacks 106 moved away from one another and the terminal plate 108. In the illustrated example of FIG. 4, the electrode stacks 106 are in a generally horizontal orientation with the respective ends 126 of the electrode stacks 106 facing one another and facing the terminal plate 108 during welding. Following formation of the welds 130, the electrode stacks 106 are moved toward one another and toward a generally vertical orientation with the respective ends 126 of the electrode stacks 106 facing the interior side 122 of the terminal plate 108, and the electrode stacks 106 and the terminal plate 108 are disposed at the battery assembly 102 in the generally vertical orientation (FIG. 2). Movement of the electrode stacks 106 after the current collector tabs 120, 124 are attached to the terminals 114, 118 may apply stress to the current collector tabs 120, 124, leading to detachment of the electrode stacks 106 to the terminal plate 108.

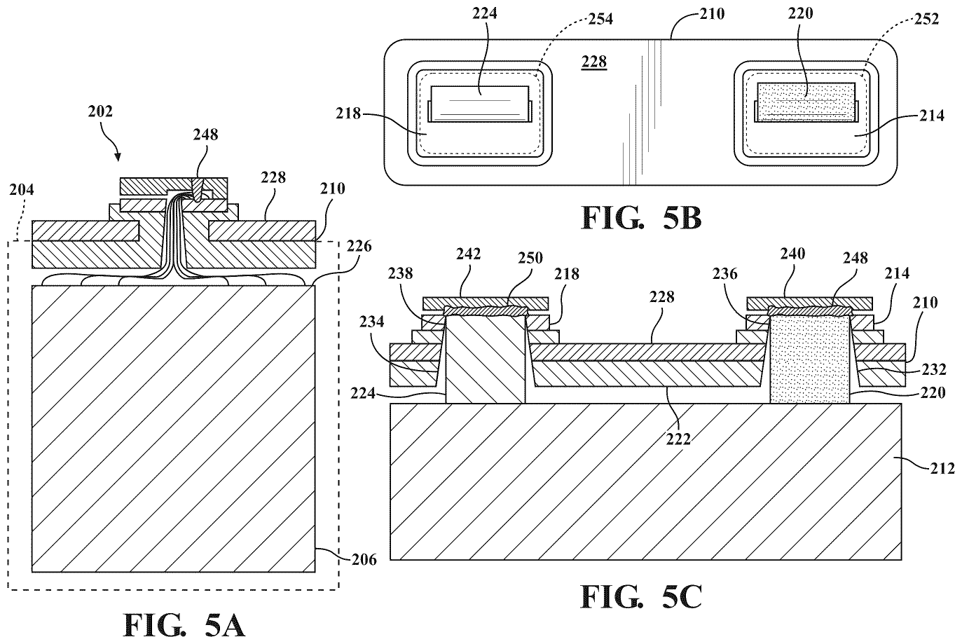

In some examples, the battery enclosure of the prismatic battery assembly includes a cap having a slot formed through the cap and a terminal plate disposed at the exterior side of the cap. The current collector tabs extend from the electrode stack and through the slot, and the current collector tabs electrically connect to the terminal plate at the exterior side of the cap. For example, and referring to FIGS. 5A-5C, 6A, 6B, and 7-9, a prismatic battery assembly 202 includes an electrode stack 206 having a plurality of current collector tabs including at least one anode current collector tab 220 and at least one cathode current collector tab 224. The plurality of current collector tabs are electrically connected to respective current collectors 212 (e.g., including at least one anode current collector and at least one cathode current collector) of the electrode stack 206 and extend from a first end 226 or edge of the electrode stack 206. The battery assembly 202 includes an enclosure 204 that accommodates the electrode stack 206 and that includes a cap 210 extending over and along the first end 226 of the electrode stack 206. The cap 210 has a first side 222 or interior side that extends along and faces the first end 226 of the electrode stack 206, and a second side 228 or exterior side that is opposite the interior side 222. The exterior side 228 of the cap 210 is exposed exterior of the battery assembly 202 and terminal plates are disposed at the exterior side 228 for electrically connecting the battery assembly 202 to the vehicle 100.

As shown in FIGS. 5A-5C, the cap 210 includes a first terminal plate 214 or negative terminal plate disposed at the exterior side 228 and electrically connected to the anode current collector tab 220 and a second terminal plate 218 or positive terminal plate disposed at the exterior side 228 and electrically connected to the cathode collector tab 224. As discussed further below, openings are formed through the cap 210 extending between the interior side 222 and the exterior side 228, and the plurality of current collector tabs extend at least partially through or within the openings to electrically connect to the terminal plates disposed at the exterior side 228 of the cap 210. Although shown as respective slots formed through the cap 210, it should be understood that the openings may include any suitable slit or through-hole or aperture formed through the cap 210.

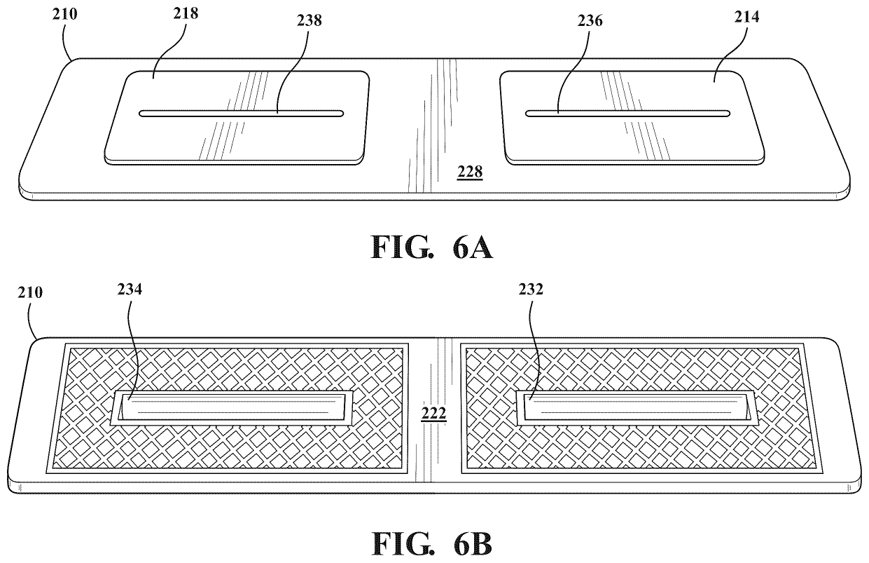

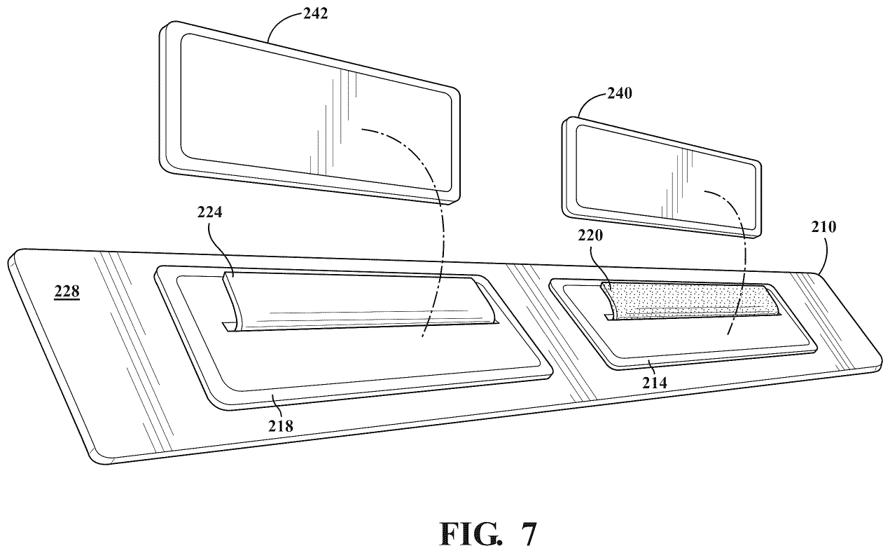

In the illustrated example, the cap 210 includes a first slot 232 that receives the anode current collector tab 220 and a second slot 234 that receives the cathode current collector tab 224 (FIG. 6B). The first slot 232 is aligned with a corresponding slot 236 formed through the negative terminal plate 214 and the second slot 234 is aligned with a corresponding slot 238 formed through the positive terminal plate 218 (FIG. 6A). Thus, with the anode current collector tab 220 extending through the first slot 232 of the cap 210 and the slot 236 of the negative terminal plate 214, and with the cathode current collector tab 224 extending through the second slot 234 of the cap 210 and the slot 238 of the positive terminal plate 218, the current collector tabs 220, 224 may be disposed at the respective terminal plates 214, 218 at the exterior side 228 of the cap 210 (FIG. 7).

Further, with the current collector tabs 220, 224 disposed through the slots 232, 234 of the cap 210 and the slots 236, 238 of the respective terminal plates 214, 218, a first cover plate 240 may be disposed at the negative terminal plate 214 to cover the anode current collector tab 220 and seal the slots 232, 236, and a second cover plate 242 may be disposed at the positive terminal plate 218 to cover the cathode current collector tab 224 and seal the slots 234, 238. The current collector tabs 220, 224 may extend at least partially along the respective terminal plates 214, 218 between the cover plates 240, 242 and the terminal plates 214, 218. Accordingly, the current collector tabs 220, 224 extend through the slots 232, 234 of the cap 210 and the slots 236, 238 of the terminal plates 214, 218 to electrically connect to the terminal plates 214, 218 at the exterior side 228 of the cap 210, with the cover plates 240, 242 attached at the terminal plates 214, 218 to hermetically seal the enclosure 204.

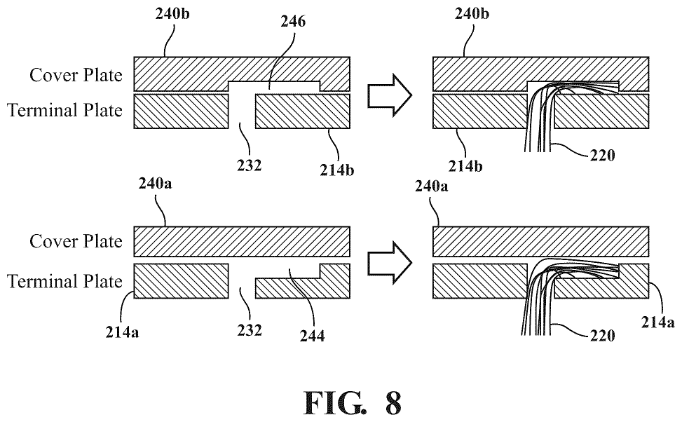

In some examples, a recess is formed between each terminal plate and the corresponding cover plate to accommodate the portions of the current collector tabs disposed between the cover plates and the terminal plates. As shown in FIG. 8, a first terminal plate 214a or first negative terminal plate includes a recess 244 (i.e., a terminal plate recess) formed adjacent to the slot 232 and extending partially through the terminal plate 214a from an upper surface of the terminal plate 214a. Thus, when the anode current collector tabs 220 are fed through the slot 232 and extend partially along the upper surface of the first terminal plate 214a, and when a planar first cover plate 240a is disposed at the first terminal plate 214a, the anode current collector tabs 220 are accommodated within the terminal plate recess 244 and electrically connected to the terminal plate 214a. The terminal plate recess 244 may allow a lower surface of the planar first cover plate 240a to directly engage the upper surface of the first terminal plate 214a and rest flush against the first terminal plate 214a to provide a more reliable seal between the cover plate 240a and the terminal plate 214a, as discussed further below.

Similarly, a second cover plate 240b may include a recess 246 (i.e., a cover plate recess) that aligns with the slot 232 extending through a second terminal plate 214b or second negative terminal plate. The second terminal plate 214b includes a planar upper surface and the recess 246 extends partially through the second cover plate 240b from a lower surface of the cover plate 240b. Thus, when the anode current collector tabs 220 are fed through the slot 232 and extend partially along the upper surface of the second terminal plate 214b, and when the second cover plate 240b is disposed at the second terminal plate 214b, the anode current collector tabs 220 are accommodated within the cover plate recess 246 and electrically connected to the terminal plate 214b. The cover plate recess 246 may allow a perimeter region of the second cover plate 240b to engage the planar upper surface of the second terminal plate 214b for forming the seal between the cover plate 240b and terminal plate 214b without reducing the thickness of the electrically conductive second terminal plate 214b.

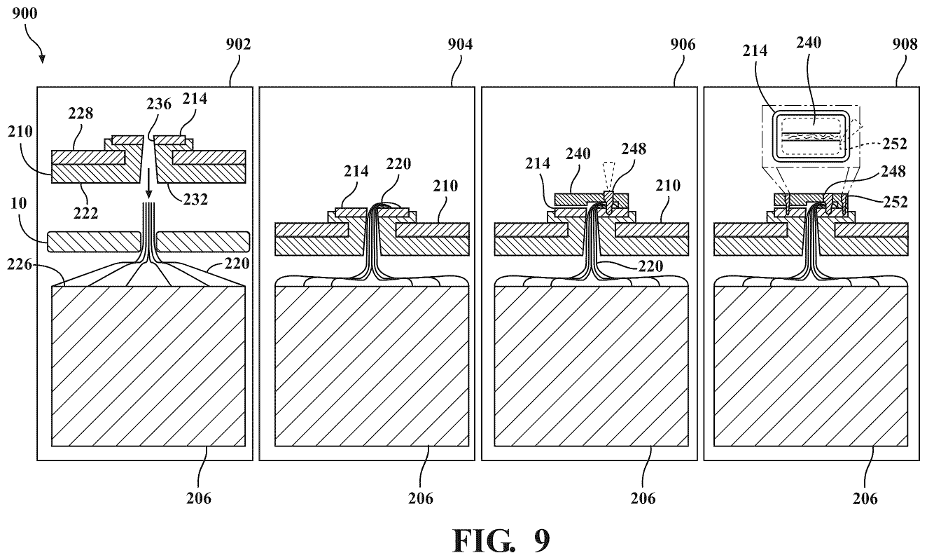

FIG. 9 provides a schematic diagram of an exemplary arrangement of operations for a method 900 of manufacturing the prismatic battery assembly 202. Although FIG. 9 shows the attachment of the anode current collector tabs 220 to the negative terminal plate 214 at the exterior side 228 of the cap 210 during manufacturing of the battery assembly 202, it should be understood that similar steps may illustrate the attachment of the cathode current collector tabs 224 to the positive terminal plate 218, and/or that the attachment of the cathode current collector tabs 224 to the positive terminal plate 218 may occur concurrently with the attachment of the anode current collector tabs 220 to the negative terminal plate 214.

At operation 902, the method 900 includes disposing the plurality of current collector tabs 220, 224 through at least one slot formed through the cap 210 of the battery enclosure 204. For example, the method 900 includes feeding the anode current collector tabs 220 through the first slot 232 of the cap 210 and feeding the cathode current collector tabs 224 through the second slot 234 of the cap 210. In the illustrated example, the method 900 further includes feeding the current collector tabs 220, 224 through the slots 236, 238 of the terminal plates 214, 218. Disposing the plurality of current collector tabs 220, 224 through the slots 232, 234 of the cap 210 and/or the slots 236, 238 of the terminal plates 214, 218 includes collecting or gathering the current collector tabs 220, 224 between grippers 10 and moving or lowering the cap 210 relative to the end 226 of the electrode stack 206 to feed the current collector tabs 220, 224 through the slots as the grippers 10 release the current collector tabs 220, 224 and move out of the way of the cap 210.

At operation 904, the method 900 includes folding the current collector tabs 220, 224 onto one side of the terminal plate 214, 218 adjacent the slot 236, 238. For example, the method 900 includes folding the anode current collector tabs 220 along the negative terminal plate 214 and folding the cathode current collector tabs 224 along the positive terminal plate 218. Thus, with the plurality of current collector tabs 220, 224 disposed at least partially through the slots 232, 234 of the cap 210 and the slots 236, 238 of the terminal plates 214, 218, the current collector tabs 220, 224 extend at least partially along the terminal plates 214, 218 at the exterior side 228 of the cap 210.

At operation 906, the method 900 includes, with the plurality of current collector tabs 220, 224 disposed through the slots 232, 234 of the cap 210, electrically connecting the plurality of current collector tabs 220, 224 to the terminal plates 214, 218 at the exterior side 228 of the cap 210. In the illustrated example, this includes attaching cover plates 240, 242 to the terminal plates 214, 218 so that the cover plates 214, 218 extend over the plurality of current collector tabs 220, 224 and the slots 236, 238 of the terminal plates 214, 218, and attaching the plurality of current collector tabs 220, 224 to the terminal plates 214, 218 and/or the cover plates 240, 242. Electrically attaching the anode current collector tabs 220 includes forming a first weld 248, such as a laser weld, between the anode current collector tabs 220 and the negative terminal plate 214 and optionally further between the anode current collector tabs 220 and the cover plate 240. Electrically attaching the cathode current collector tabs 224 includes forming a second weld 250, such as a laser weld, between the cathode current collector tabs 224 and the positive terminal plate 218 and optionally further between the cathode current collector tabs 224 and the cover plate 242.

At operation 908, the method 900 includes forming respective perimeter seals, such as perimeter laser welds, between the cover plates 240, 242 and the terminal plates 214, 218. For example, a first perimeter seal 252 is formed between the anode terminal plate 214 and the cover plate 240 and a second perimeter seal 254 is formed between the cathode terminal plate 218 and the cover plate 242. The perimeter seals 252, 254 hermetically seal the battery enclosure 204.

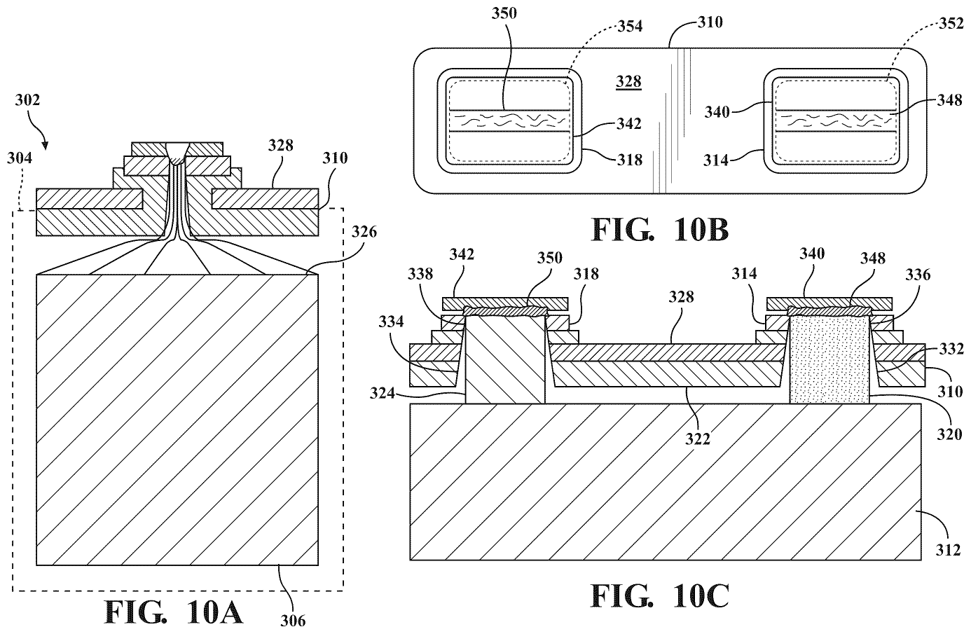

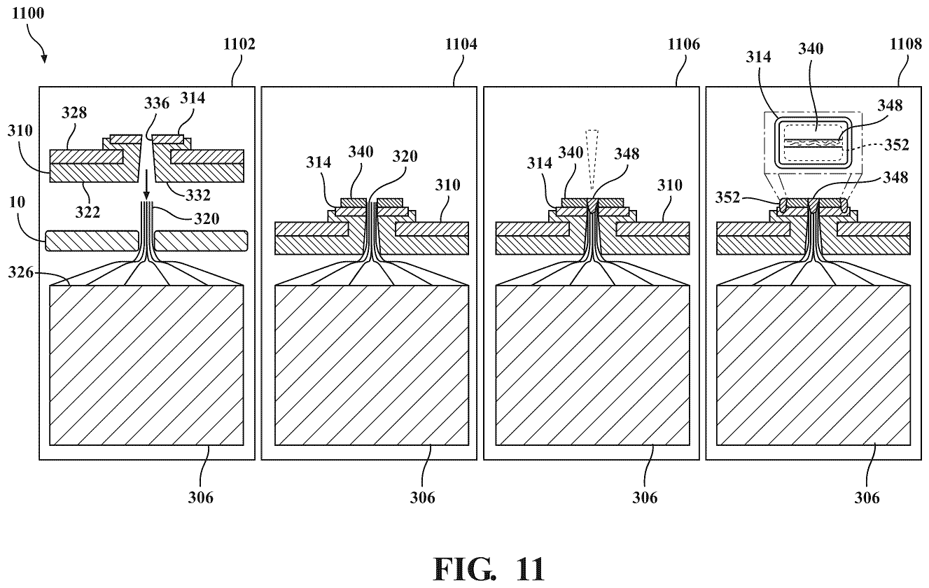

In some examples, the current collector tabs extend from the electrode stack and through the slot formed through the cap and also through a slot formed through the terminal plate disposed at the exterior side of the cap. The current collector tabs are electrically connected to the terminal plate at or within the slot of the terminal plate. For example, and referring to FIGS. 10A-10C and 11, a prismatic battery assembly 302 includes an electrode stack 306 having a plurality of current collector tabs including at least one anode current collector tab 320 and at least one cathode current collector tab 324. The plurality of current collector tabs are electrically connected to respective current collectors 312 (e.g., including at least one anode current collector and at least one cathode current collector) of the electrode stack 306 and extend from a first end 326 or edge of the electrode stack 306. The battery assembly 302 includes an enclosure 304 that accommodates the electrode stack 306 and that includes a cap 310 extending over and along the first end 326 of the electrode stack 306. The cap 310 has a first side 322 or interior side that extends along and faces the first end 326 of the electrode stack 306, and a second side 328 or exterior side that is opposite the interior side 322. The exterior side 328 of the cap 310 is exposed exterior of the battery assembly 302 and terminal plates are disposed at the exterior side 328 for electrically connecting the battery assembly 302 to the vehicle 100.

As shown in FIGS. 10A-10C, the cap 310 includes a first terminal plate 314 or negative terminal plate disposed at the exterior side 328 and electrically connected to the anode current collector tab 320 and a second terminal plate 318 or positive terminal plate disposed at the exterior side 328 and electrically connected to the cathode collector tab 324. As discussed further below, openings are formed through the cap 310 extending between the interior side 322 and the exterior side 328, and the plurality of current collector tabs extend at least partially through or within the openings to electrically connect to the terminal plates disposed at the exterior side 328 of the cap 310. Although shown as respective slots formed through the cap 310, it should be understood that the openings may include any suitable slit or through-hole or aperture formed through the cap 310.

In the illustrated example, the cap 310 includes a first slot 332 that receives the anode current collector tab 320 and a second slot 334 that receives the cathode current collector tab 324. The first slot 332 is aligned with a corresponding slot 336 formed through the negative terminal plate 314 and the second slot 334 is aligned with a corresponding slot 338 formed through the positive terminal plate 318. Thus, with the anode current collector tab 320 extending through the first slot 332 of the cap 310 and the slot 336 of the negative terminal plate 314, and with the cathode current collector tab 324 extending through the second slot 334 of the cap 310 and the slot 338 of the positive terminal plate 318, the current collector tabs 320, 324 may be disposed at the respective terminal plates 314, 318 at the exterior side 328 of the cap 310.

With the current collector tabs 320, 324 disposed through the slots 332, 334 of the cap 310 and the slots 336, 338 of the respective terminal plates 314, 318, a first cover plate 340 may be disposed at the negative terminal plate 314 to receive the anode current collector tab 320 and seal the slots 332, 336, and a second cover plate 342 may be disposed at the positive terminal plate 318 to receive the cathode current collector tab 324 and seal the slots 334, 338. As shown in FIG. 11, the cover plates 340, 342 are two-piece or clamp-style cover plates. Thus, when the current collector tabs 320, 324 are disposed through the slots 332, 334 of the cap 310 and through the slots 334, 338 of the terminal plates 314, 318, the current collector tabs 320, 324 extend above the terminal plates 314, 318 and through slots or spaces between respective portions or sides of the cover plates 340, 342. The sides of the respective cover plates 340, 342 are brought together to capture, clamp, or otherwise retain the current collector tabs 320, 324 therebetween. The current collector tabs 320, 324 are then electrically connected to the terminal plates 314, 318 by attaching the current collector tabs 320, 324 at or within the slots 336, 338 of the terminal plates 314, 318. For example, a first weld 348, such as a laser weld, is formed between the anode current collector tabs 320 and the slot 336 of the negative terminal plate 314 and a second weld 350, such as a laser weld, is formed between the cathode current collector tabs 324 and the slot 338 of the positive terminal plate 318. The first weld 348 and the second weld 350 may use fillet wire to fill gaps between the current collector tabs 320, 324 and the slots 336, 338 and hermetically seal the enclosure 304.

FIG. 11 provides a schematic diagram of an exemplary arrangement of operations for a method 1100 of manufacturing the prismatic battery assembly 302. Although FIG. 11 shows the attachment of the anode current collector tabs 320 to the negative terminal plate 314 at the exterior side 328 of the cap 310 during manufacturing of the battery assembly 302, it should be understood that similar steps may illustrate the attachment of the cathode current collector tabs 324 to the positive terminal plate 318, and/or that the attachment of the cathode current collector tabs 324 to the positive terminal plate 318 may occur concurrently with the attachment of the anode current collector tabs 320 to the negative terminal plate 314.

At operation 1102, the method 1100 includes disposing the plurality of current collector tabs 320, 324 through at least one slot formed through the cap 310 of the battery enclosure 304. For example, the method 1100 includes feeding the anode current collector tabs 320 through the first slot 332 of the cap 310 and feeding the cathode current collector tabs 324 through the second slot 334 of the cap 310. In the illustrated example, the method 1100 further includes feeding the current collector tabs 320, 324 through the slots 336, 338 of the terminal plates 314, 318. Disposing the plurality of current collector tabs 320, 324 through the slots 332, 334 of the cap 310 and/or the slots 336, 338 of the terminal plates 314, 318 includes collecting or gathering the current collector tabs 320, 324 between grippers 10 and moving or lowering the cap 310 relative to the end 326 of the electrode stack 306 to feed the current collector tabs 320, 324 through the slots as the grippers 10 release the current collector tabs 320, 324 and move out of the way of the cap 310.

At operation 1104, the method 1100 includes applying two-piece or clamp-style cover plates 340, 342 at the terminal plates 314, 318 so that the current collector tabs 320, 324 are disposed between respective sides or portions of the cover plates 340, 342. For example, the first cover plate 340 is disposed at the negative terminal plate 314 with the anode current collector tabs 320 disposed between respective sides or portions of the cover plate 340, and the second cover plate 342 is disposed at the positive terminal plate 318 with the cathode current collector tabs 324 disposed between respective sides or portions of the cover plate 342. The cover plates 340, 342 may be pressed or clamped together to capture or retain the current collector tabs 320, 324 between the sides or portions of the respective cover plates 340, 342.

At operation 1106, the method 1100 includes, with the plurality of current collector tabs 320, 324 disposed through the slots 332, 334 of the cap 310 and between the portions of the respective cover plates 340, 342, electrically connecting the plurality of current collector tabs 320, 324 to the terminal plates 314, 318 at or within the slots 332, 334 of the cap 310. In the illustrated example, this includes trimming ends of the current collector tabs 320, 324 and attaching the plurality of current collector tabs 320, 324 at the slots 332, 334 of the terminal plates 314, 318 and attaching the plurality of current collector tabs 320, 324 at the cover plates 340, 342. Electrically attaching the anode current collector tabs 320 includes forming the first weld 348, such as a laser weld, between the anode current collector tabs 320 and the slot 336 of the negative terminal plate 314 and optionally further between the anode current collector tabs 320 and the cover plate 340. Electrically attaching the cathode current collector tabs 324 includes forming the second weld 350, such as a laser weld, between the cathode current collector tabs 324 and the slot 338 of the positive terminal plate 318 and optionally further between the cathode current collector tabs 324 and the cover plate 342.

At operation 1108, the method 1100 includes forming respective perimeter seals, such as a perimeter laser welds, between the cover plates 340, 342 and the terminal plates 314, 318. For example, a first perimeter seal 352 is formed between the anode terminal plate 314 and the cover plate 340 and a second perimeter seal 354 is formed between the cathode terminal plate 318 and the cover plate 342. The perimeter seals 352, 354 may hermetically seal the battery enclosure 304.

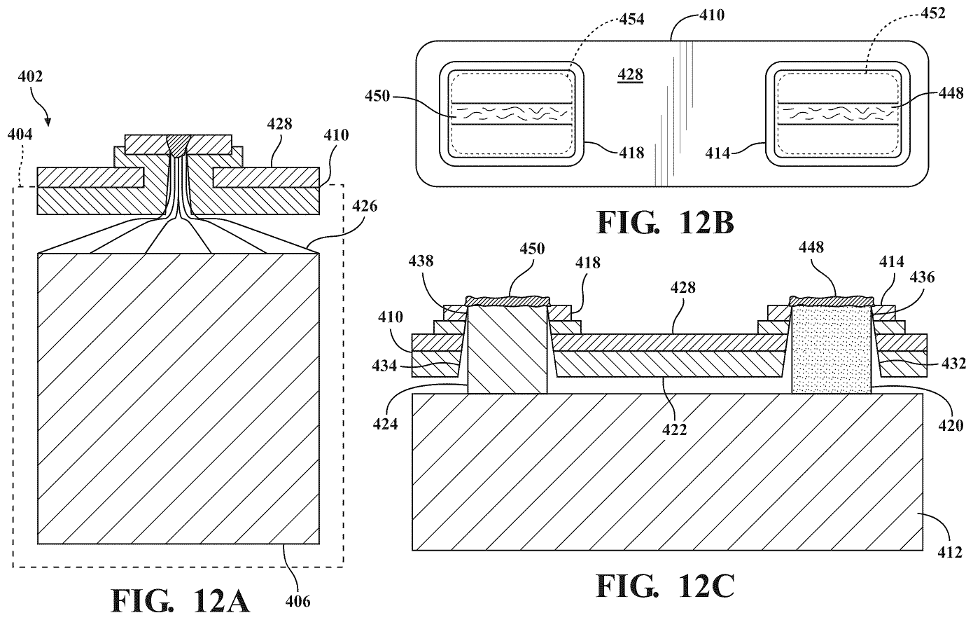

Optionally, the current collector tabs extend from the electrode stack and through the slot formed through the cap and also through a slot formed through the terminal plate disposed at the exterior side of the cap, and the current collector tabs are electrically connected to the terminal plate at or within the slot of the terminal plate without the use of a cover plate to seal the slots of the terminal plate. For example, and referring to FIGS. 12A-12C, 13 and 14, a prismatic battery assembly 402 includes an electrode stack 406 having a plurality of current collector tabs including at least one anode current collector tab 420 and at least one cathode current collector tab 424. The plurality of current collector tabs are electrically connected to respective current collectors 412 (e.g., including at least one anode current collector and at least one cathode current collector) of the electrode stack 406 and extend from a first end 426 or edge of the electrode stack 406. The battery assembly 402 includes an enclosure 404 that accommodates the electrode stack 406 and that includes a cap 410 extending over and along the first end 426 of the electrode stack 406. The cap 410 has a first side 422 or interior side that extends along and faces the first end 426 of the electrode stack 406, and a second side 428 or exterior side that is opposite the interior side 422. The exterior side 428 of the cap 410 is exposed exterior of the battery assembly 402 and terminal plates are disposed at the exterior side 428 for electrically connecting the battery assembly 402 to the vehicle 100.

As shown in FIGS. 12A-12C, the cap 410 includes a first terminal plate 414 or negative terminal plate disposed at the exterior side 428 and electrically connected to the anode current collector tab 420 and a second terminal plate 418 or positive terminal plate disposed at the exterior side 428 and electrically connected to the cathode collector tab 424. Openings are formed through the cap 410 extending between the interior side 422 and the exterior side 428, and the plurality of current collector tabs extend at least partially through or within the openings to electrically connect to the terminal plates disposed at the exterior side 428 of the cap 410. Although shown as respective slots formed through the cap 410, it should be understood that the openings may include any suitable slit or through-hole or aperture formed through the cap 410.

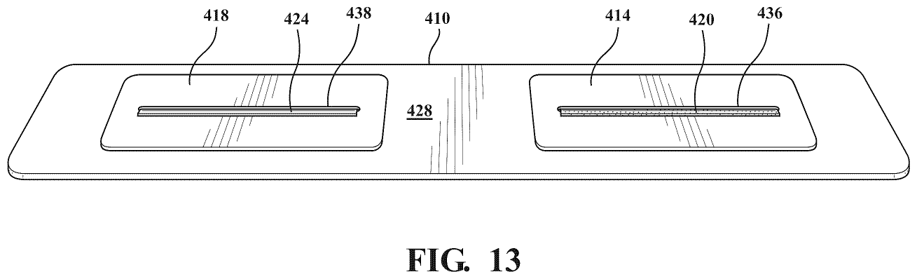

In the illustrated example, the cap 410 includes a first slot 432 that receives the anode current collector tab 420 and a second slot 434 that receives the cathode current collector tab 424. The first slot 432 is aligned with a corresponding slot 436 formed through the negative terminal plate 414 and the second slot 434 is aligned with a corresponding slot 438 formed through the positive terminal plate 418 (FIG. 13). Thus, with the anode current collector tab 420 extending through the first slot 432 of the cap 410 and the slot 436 of the negative terminal plate 414, and with the cathode current collector tab 424 extending through the second slot 434 of the cap 410 and the slot 438 of the positive terminal plate 418, the current collector tabs 420, 424 may be disposed at the respective terminal plates 414, 418 at the exterior side 428 of the cap 410. That is, the current collector tabs 420, 424 extend through the slots 436, 438 of the terminal plates 414, 418 and partially above the terminal plates 414, 418 and/or along the exterior side of the terminal plates 414, 418. This allows the current collector tabs 420, 424 to be attached directly to the terminal plates 414, 418 at or within the slots 436, 438 of the terminal plates 414, 418 and seal the battery enclosure 404 without an added cover plate, as discussed further below. For example, a first weld 448, such as a laser weld, is formed between the anode current collector tabs 420 and the slot 436 of the negative terminal plate 414 and a second weld 450, such as a laser weld, is formed between the cathode current collector tabs 424 and the slot 438 of the positive terminal plate 418. Fillet wire may be used during welding of the current collector tabs 420, 424 at the slots 436, 438 of the terminal plates 414, 418 to fill gaps and seal the enclosure 404.

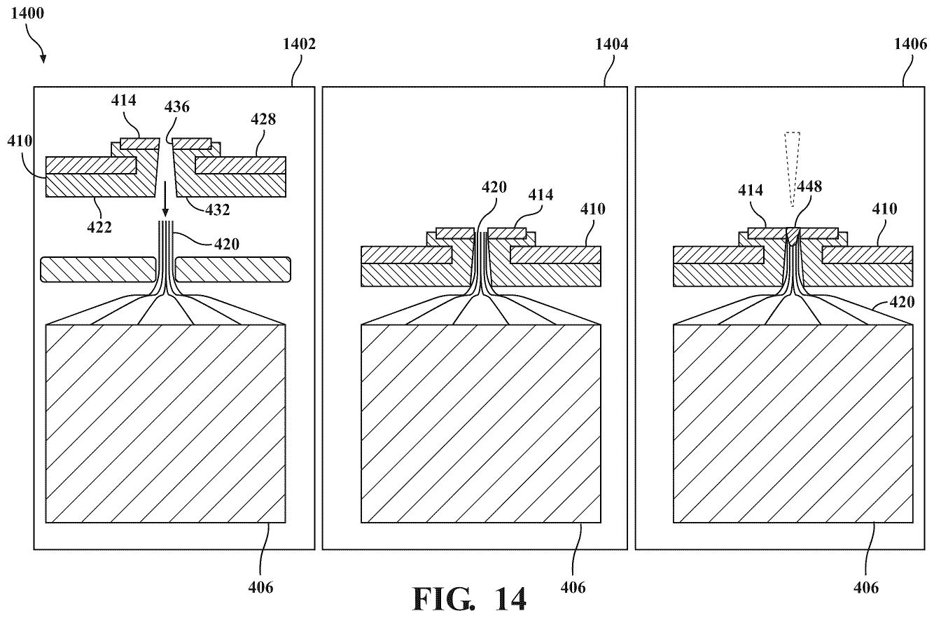

FIG. 14 provides a schematic diagram of an exemplary arrangement of operations for a method 1400 of manufacturing the prismatic battery assembly 402. Although FIG. 14 shows the attachment of the anode current collector tabs 420 to the negative terminal plate 414 at the exterior side 428 of the cap 410 during manufacturing of the battery assembly 402, it should be understood that similar steps may illustrate the attachment of the cathode current collector tabs 424 to the positive terminal plate 418, and/or that the attachment of the cathode current collector tabs 424 to the positive terminal plate 418 may occur concurrently with the attachment of the anode current collector tabs 420 to the negative terminal plate 414.

At operation 1402, the method 1400 includes disposing the plurality of current collector tabs 420, 424 through at least one slot formed through the cap 410 of the battery enclosure 404. For example, the method 1400 includes feeding the anode current collector tabs 420 through the first slot 432 of the cap 410 and feeding the cathode current collector tabs 424 through the second slot 434 of the cap 410. In the illustrated example, the method 1400 further includes feeding the current collector tabs 420, 424 through the slots 436, 438 of the terminal plates 414, 418. Disposing the plurality of current collector tabs 420, 424 through the slots 432, 434 of the cap 410 and/or the slots 436, 438 of the terminal plates 414, 418 includes collecting or gathering the current collector tabs 420, 424 between grippers 10 and moving or lowering the cap 410 relative to the end 426 of the electrode stack 406 to feed the current collector tabs 420, 424 through the slots as the grippers 10 release the current collector tabs 420, 424 and move out of the way of the cap 410.

With the current collector tabs 420, 424 extending through the slots 436, 438 of the terminal plates 414, 418, the current collector tabs 420, 424 extend at least partially above the upper surfaces of the terminal plates 414, 418. Thus, at operation 1404, the method 1400 may include trimming the current collector tabs 420, 424, such that ends of the current collector tabs 420, 424 may be planar with or extend only slightly above the upper surfaces of the terminal plates 414, 418. In other words, the ends of the anode current collector tabs 420 may be disposed at or near the upper surface of the negative terminal plate 414 and the ends of the cathode current collector tabs 424 may be disposed at or near the upper surface of the positive terminal plate 418.

At operation 1406, the method 1400 includes, with the plurality of current collector tabs 420, 424 disposed through the slots 432, 434 of the cap 410, electrically connecting the plurality of current collector tabs 420, 424 to the terminal plates 414, 418 at the exterior side 428 of the cap 410. In the illustrated example, attaching the plurality of current collector tabs 420, 424 to the terminal plates 414, 418 at or within the slots 436, 438 of the terminal plates 414, 418. Electrically attaching the anode current collector tabs 420 includes forming the first weld 448, such as a laser weld, using fillet wire and between the anode current collector tabs 420 and the negative terminal plate 414 at or within the slot 436 of the negative terminal plate 414. Electrically attaching the cathode current collector tabs 424 includes forming the second weld 450, such as a laser weld, using fillet wire and between the cathode current collector tabs 424 and the positive terminal plate 418 at or within the slot 438 of the positive terminal plate 418. The first weld 448 and the second weld 450 may hermetically seal the battery enclosure 404. Optionally, respective perimeter seals 452, 454, such as perimeter laser welds, may be formed between the terminal plates 414, 418 and the cap 410.

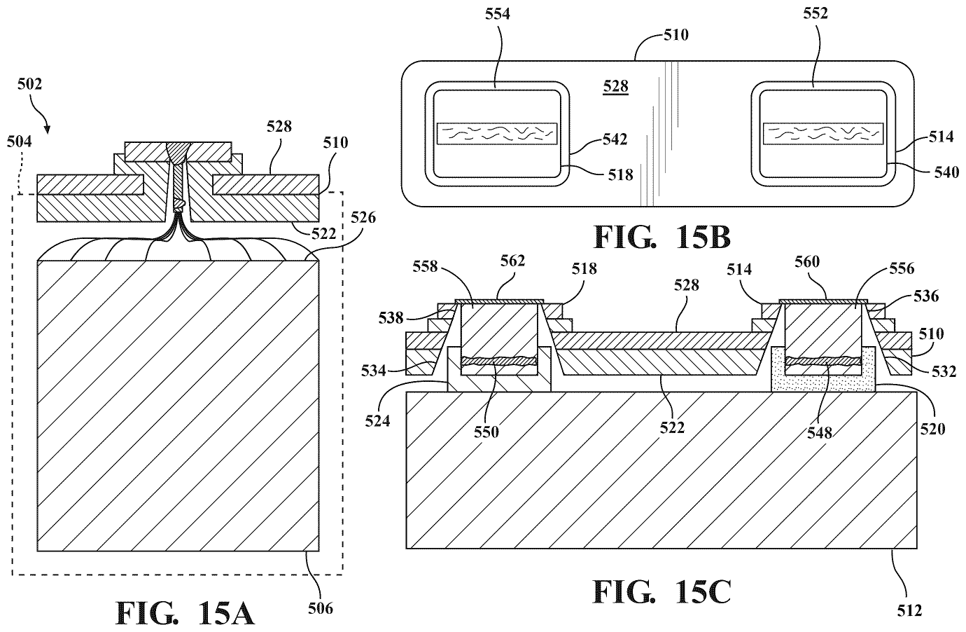

In some examples, the terminal plate at the exterior side of the cap is electrically connected to a terminal lead or lead tab that extends partially within the slot of the cap. The current collector tabs extend from the electrode stack and partially along, within or through the slot and attach to the terminal lead within the slot to electrically connect the current collects to the terminal plates at the exterior side of the cap. For example, and referring to FIGS. 15A-15C, 16A, 16B and 17, a prismatic battery assembly 502 includes an electrode stack 506 having a plurality of current collector tabs including at least one anode current collector tab 520 and at least one cathode current collector tab 524. The plurality of current collector tabs are electrically connected to respective current collectors 512 (e.g., including at least one anode current collector and at least one cathode current collector) of the electrode stack 506 and extend from a first end 526 or edge of the electrode stack 506. The battery assembly 502 includes an enclosure 504 that accommodates the electrode stack 506 and that includes a cap 510 extending over and along the first end 526 of the electrode stack 506. The cap 510 has a first side 522 or interior side that extends along and faces the first end 526 of the electrode stack 506, and a second side 528 or exterior side that is opposite the interior side 522. The exterior side 528 of the cap 510 is exposed exterior of the battery assembly 502 and terminal plates are disposed at the exterior side 528 for electrically connecting the battery assembly 502 to the vehicle 100.

As shown in FIGS. 15A-15C, the cap 510 includes a first terminal plate 514 or negative terminal plate disposed at the exterior side 528 and electrically connected to the anode current collector tab 520 and a second terminal plate 518 or positive terminal plate disposed at the exterior side 528 and electrically connected to the cathode collector tab 524. As discussed further below, openings are formed through the cap 510 extending at least partially between the interior side 522 and the exterior side 528, and the plurality of current collector tabs extend partially through or within the openings to electrically connect to the terminal plates disposed at the exterior side 528 of the cap 510. Although shown as respective slots formed through the cap 510, it should be understood that the openings may include any suitable slit or through-hole or aperture formed at least partially through the cap 510.

In the illustrated example, the cap 510 includes a first slot 532 that receives the anode current collector tab 520 and a second slot 534 that receives the cathode current collector tab 524. The first slot 532 is aligned with the negative terminal plate 514 and the second slot 534 is aligned with the positive terminal plate 518. A first terminal lead 556 or a negative terminal lead tab is electrically connected to the negative terminal plate 514 and extends partially within the first slot 532 from the negative terminal plate 514 toward the first end 526 of the electrode stack 506. A second terminal lead 558 or a positive terminal lead tab is electrically connected to the positive terminal plate 518 and extends partially within the second slot 534 from the positive terminal plate 518 toward the first end 526 of the electrode stack 506. The negative terminal lead tab 556 attaches to the anode current collector tab 520 at or within the first slot 532 to electrically connect the anode current collector tab 520 and the negative terminal plate 514, and the positive terminal lead tab 558 attaches to the cathode current collector tab 524 at or within the second slot 534 to electrically connect the cathode current collector tab 524 and the positive terminal plate 518. The negative terminal plate 514 may be attached at the cap 210 to hermetically seal the first slot 536 and the positive terminal plate 518 may be attached at the cap 210 to hermetically seal the second slot 538. In some examples, a first cover plate 540 is disposed at the negative terminal plate 514 and a second cover plate 542 is disposed at the positive terminal plate 518 to seal the enclosure 504.

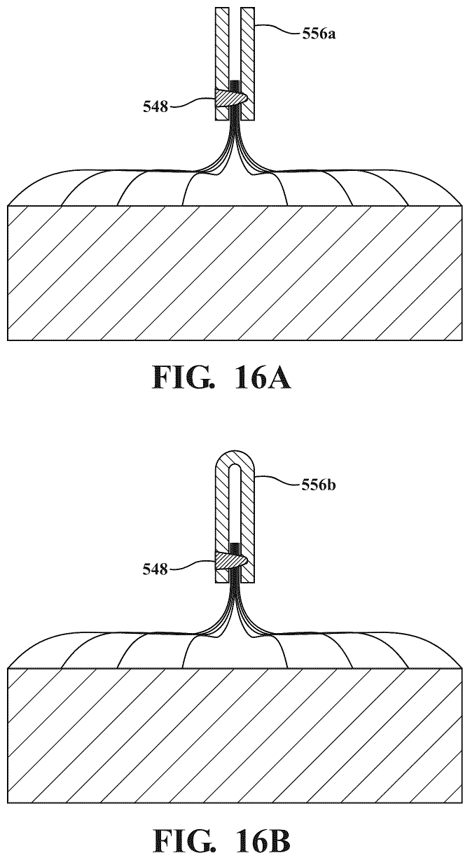

Any suitable electrically conductive terminal lead tab may be used to attach between the plurality of current collector tabs and the terminal plate. As shown in FIG. 16A, a first terminal lead tab 556a or first negative terminal lead tab is a two-piece or clamp-style terminal lead tab that receives the plurality of current collector tabs between respective sides or portions of the terminal lead tab 556a. The two sides or portions of the terminal lead tab 556a are pressed together or clamped to retain the plurality of current collector tabs thereat. As shown in FIG. 16B, a second terminal lead tab 556b or second negative terminal lead tab is a U-shaped terminal lead tab that receives the plurality of current collector tabs between respective legs or portions of the U-shaped terminal lead tab 556b. The two legs or portions of the U-shaped terminal lead tab 556b are pressed together, crimped, or clamped to retain the plurality of current collector tabs thereat.

Further, the plurality of current collector tabs are welded, such as via laser welding or ultrasonic welding, to the respective terminal lead tabs to electrically connect the plurality of current collector tabs and the terminal lead tabs. For example, a first weld 548 is formed between the anode current collector tabs 520 and the negative terminal lead tab 556 and a second weld 550 is formed between the cathode current collector tabs 524 and the positive terminal lead tab 558.

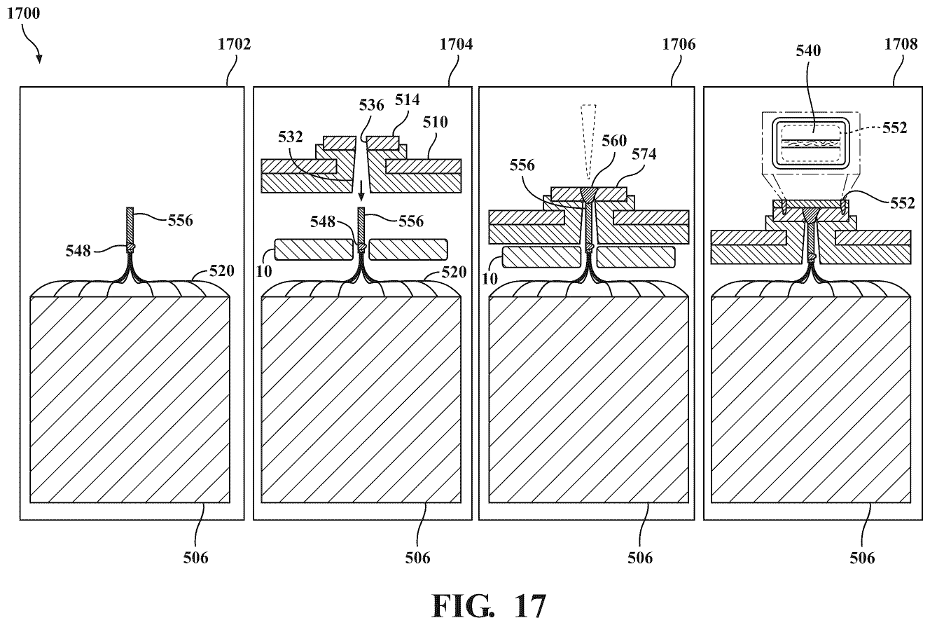

FIG. 17 provides a schematic diagram of an exemplary arrangement of operations for a method 1700 of manufacturing the prismatic battery assembly 502. Although FIG. 17 shows the attachment of the anode current collector tabs 520 to the negative terminal plate 514 via the negative terminal lead tab 556 during manufacturing of the battery assembly 502, it should be understood that similar steps may illustrate the attachment of the cathode current collector tabs 524 to the positive terminal plate 518 via the positive terminal lead tab 558, and/or that the attachment of the cathode current collector tabs 524 to the positive terminal lead tab 558 and positive terminal plate 518 may occur concurrently with the attachment of the anode current collector tabs 520 to the negative terminal lead tab 556 and negative terminal plate 514.

At operation 1702, the method 1700 includes attaching the plurality of current collector tabs 520, 524 to the terminal lead tabs 556, 558 as discussed above. For example, the method 1700 includes attaching the anode current collector tabs 520 to the negative terminal lead 556 and attaching the cathode current collector tabs 524 to the positive terminal lead 558.

With the plurality of current collector tabs 520, 524 attached to the terminal lead tabs 556, 558, the method 1700 includes at operation 1704 disposing the plurality of current collector tabs 520, 524 and/or the terminal lead tabs 556, 558 partially through the slots 532, 534 formed through the cap 510 of the battery enclosure 504. For example, the method 1700 includes feeding the anode current collector tabs 520 and negative terminal lead tab 556 through the first slot 532 of the cap 510 and feeding the cathode current collector tabs 524 and positive terminal lead tab 558 through the second slot 534 of the cap 510. In the illustrated example, the method 1700 further includes feeding the terminal lead tabs 556, 558 through slots 536, 538 of the terminal plates 514, 518. Disposing the plurality of current collector tabs 520, 524 through the slots 532, 534 of the cap 510 and/or the slots 536, 538 of the terminal plates 514, 518 includes collecting or gathering the terminal lead tabs 556, 558 between grippers 10 and moving or lowering the cap 510 relative to the end 526 of the electrode stack 506 to feed the terminal lead tabs 556, 558 and the current collector tabs 520, 524 at least partially through the slots.

At operation 1706, the method 1700 includes, with the terminal lead tabs 556, 558 and the plurality of current collector tabs 520, 524 disposed through the slots 532, 534 of the cap 510, attaching the terminal lead tabs 556, 558 to the terminal plates 514, 518 to electrically connect the plurality of current collector tabs 520, 524 and the respective terminal plates 514, 518. In the illustrated example, this includes feeing the terminal lead tabs 556, 558 at least partially through the slots 536, 538 of the terminal plates 514, 518 and welding, such as laser welding or ultrasonic welding, the terminal lead tabs 556, 558 to the terminal plates 514, 518. Thus, a first weld 560 between the negative terminal lead tab 556 and the negative terminal plate 514 electrically connects the anode current collector tabs 520 and the negative terminal plate 514, and a second weld 562 between the positive terminal lead tab 558 and the positive terminal plate 518 electrically connects the cathode current collector tabs 524 and the positive terminal plate 518. The grippers 10 may retain the terminal lead tabs 556, 558 during welding and release the terminal lead tabs 556, 558 following welding. The first weld 560 and the second weld 562 may hermetically seal the enclosure 504 of the battery assembly 502.

Optionally, at operation 1708, the method 1700 includes positioning cover plates 540, 542 at the terminal plates 514, 518 and forming respective perimeter seals, such as perimeter laser welds, between the cover plates 540, 542 and the terminal plates 514, 518. The cover plates 540, 542 may extend over and along the first weld 560 and the second weld 562. Thus, a first perimeter seal 552 is formed between the anode terminal plate 514 and the cover plate 540 and a second perimeter seal 554 is formed between the cathode terminal plate 518 and the cover plate 542. The perimeter seals 552, 554 may ensure hermetic sealing of the battery enclosure 504.

Thus, because the current collector tabs extend at least partially through slots formed in the cap of the battery enclosure for electrically connecting to the terminal plates at the exterior side of the cap, bending of the current collector tabs during battery manufacturing is reduced. This improves the integrity of physical and electrical connections within the battery assembly. Further, the electrical pathway between the current collectors and the battery terminals is shortened, which allows for the space or height between the cap and the electrode stack to be reduced and improves battery packaging efficiency.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A method for manufacturing a prismatic battery assembly, the method comprising:
disposing a plurality of current collector tabs at least partially through a slot of a cap of an enclosure, the plurality of current collector tabs electrically connected to respective current collectors of an electrode stack and extending from an end of the electrode stack, the enclosure accommodating the electrode stack, the cap having an interior side that extends along the end of the electrode stack and an exterior side opposite the interior side, and the slot formed through the cap between the exterior side and the interior side;
with the plurality of current collector tabs disposed at least partially through the slot, electrically connecting the plurality of current collector tabs to a terminal plate disposed at the exterior side of the cap; and
with the plurality of current collector tabs electrically connected to the terminal plate, hermetically sealing the enclosure.

2. The method of claim 1, wherein disposing the plurality of current collector tabs at least partially through the slot includes:
collecting the plurality of current collector tabs; and
moving the cap relative to the end of the electrode stack to feed the plurality of current collector tabs at least partially through the slot.

3. The method of claim 1, wherein, with the plurality of current collector tabs disposed at least partially through the slot, the plurality of current collector tabs extend through the slot of the cap and at least partially along the terminal plate at the exterior side of the cap, the plurality of current collector tabs disposed between the terminal plate and a cover plate, the cover plate hermetically sealing the enclosure.

4. The method of claim 3, wherein, with the plurality of current collector tabs extending at least partially along the terminal plate, the plurality of current collector tabs are accommodated within a recess formed between the terminal plate and the cover plate.

5. The method of claim 4, wherein the recess extends partially into one selected from the group consisting of (i) the terminal plate and (ii) the cover plate.

6. The method of claim 1, wherein, with the plurality of current collector tabs disposed at least partially through the slot, the plurality of current collector tabs extend through the slot of the cap and the plurality of current collector tabs extend at least partially through a slot of the terminal plate.

7. The method of claim 6, wherein electrically connecting the plurality of current collector tabs to the terminal plate includes attaching the plurality of current collector tabs to the terminal plate at the slot of the terminal plate.

8. The method of claim 7, further comprising attaching a cover plate to the terminal plate, the cover plate extending over the plurality of current collector tabs and the slot of the terminal plate, and the cover plate hermetically sealing the enclosure.

9. The method of claim 1, wherein electrically connecting the plurality of current collector tabs to the terminal plate includes attaching the plurality of current collector tabs to a lead tab electrically connected to the terminal plate and extending within the slot of the cap.

10. The method of claim 1, wherein electrically connecting the plurality of current collector tabs to the terminal plate includes laser welding the plurality of current collector tabs to the terminal plate.

11. A prismatic battery assembly comprising:
an electrode stack having a plurality of current collector tabs electrically connected to respective current collectors of the electrode stack, the plurality of current collector tabs extending from an end of the electrode stack; and
an enclosure accommodating the electrode stack, the enclosure including a cap having:
an interior side that extends along the end of the electrode stack;
an exterior side opposite the interior side;
a slot formed through the cap between the exterior side and the interior side, the plurality of current collector tabs extending at least partially through the slot; and
a terminal plate disposed at the exterior side and electrically connected to the plurality of current collector tabs.

12. The prismatic battery assembly of claim 11, wherein the plurality of current collector tabs extend through the slot of the cap and at least partially along the terminal plate at the exterior side of the cap, the plurality of current collector tabs disposed between the terminal plate and a cover plate.

13. The prismatic battery assembly of claim 12, wherein the plurality of current collector tabs are accommodated within a recess formed between the terminal plate and the cover plate.

14. The prismatic battery assembly of claim 11, wherein the plurality of current collector tabs extend through the slot of the cap and at least partially through a slot of the terminal plate, the plurality of current collector tabs attached to the terminal plate at the slot of the terminal plate.

15. The prismatic battery assembly of claim 11, wherein the plurality of current collector tabs extend partially through the slot and are attached to a lead tab electrically connected to the terminal plate and extending within the slot of the cap.

16. A vehicle comprising:
a prismatic battery assembly including:
an electrode stack having a plurality of current collector tabs electrically connected to respective current collectors of the electrode stack, the plurality of current collector tabs extending from an end of the electrode stack; and
an enclosure accommodating the electrode stack, the enclosure including a cap having:
an interior side that extends along the end of the electrode stack;
an exterior side opposite the interior side;
a slot formed through the cap between the exterior side and the interior side, the plurality of current collector tabs extending at least partially through the slot; and
a terminal plate disposed at the exterior side and electrically connected to the plurality of current collector tabs.

17. The vehicle of claim 16, wherein the plurality of current collector tabs extend through the slot of the cap and at least partially along the terminal plate at the exterior side of the cap, the plurality of current collector tabs disposed between the terminal plate and a cover plate.

18. The vehicle of claim 17, wherein the plurality of current collector tabs are accommodated within a recess formed between the terminal plate and the cover plate.

19. The vehicle of claim 16, wherein the plurality of current collector tabs extend through the slot of the cap and at least partially through a slot of the terminal plate, the plurality of current collector tabs attached to the terminal plate at the slot of the terminal plate.

20. The vehicle of claim 16, wherein the plurality of current collector tabs extend partially through the slot and are attached to a lead tab electrically connected to the terminal plate and extending within the slot of the cap.
